(19) United States
(12) Patent Application Publication
(10) Pub. No.: US 2024/0353733 A1
(43) Pub. Date: Oct. 24, 2024

(54) Wavelength Conversion Device

(71) Applicant: Nippon Telegraph and Telephone Corporation, Tokyo (JP)

(72) Inventors: Osamu Tadanaga, Musashino-shi, Tokyo (JP); Takushi Kazama, Musashino-shi, Tokyo (JP)

(21) Appl. No.: 18/685,318

(22) PCT Filed: Sep. 15, 2021
(86) PCT No.: PCT/JP2021/033985

§ 371 Date: Feb. 21, 2024

(51) Int. Cl. G02F 1/35; G02F 1/377

(52) U.S. Cl. CPC G02F 1/3501; G02F 1/377; G02F 2202/20

(57) ABSTRACT

The present disclosure provides a wavelength conversion element that uses a second-order nonlinear optical effect and can suppress unintended wavelength conversion due to high-order quasi-phase matching. A wavelength conversion element according to the present disclosure includes: a substrate; and a core that is bonded onto the substrate and performs wavelength conversion of incident light, the core has a structure in which first spontaneous polarization and second spontaneous polarization are periodically inverted with respect to an optical axis direction, and the wavelength conversion element has a structure in which a cross-sectional area of the core changes with respect to the optical axis direction such that the cross-sectional area is maximum at an end portion and is minimum at a central portion in a region having the first spontaneous polarization and a region having the second spontaneous polarization.

### TECHNICAL FIELD

The present disclosure relates to a wavelength conversion element, and more specifically, to a wavelength conversion element using a nonlinear optical effect.

### BACKGROUND ART

Wavelength conversion technologies using a second-order nonlinear optical effect have been put into practical use in fields such as optical processing, medical care, and biotechnology, in addition to wavelength conversion of optical signals in optical communication. For example, a light source that outputs light in a wavelength range that cannot be directly output by a semiconductor laser in an ultraviolet range, a visible light range, an infrared range, and a terahertz range, a light source that requires high output intensity that cannot be obtained by a semiconductor laser even in a wavelength range that can be directly output by a semiconductor laser, and the like can be cited as an application example. In particular, a wavelength conversion element having a periodically poled optical waveguide to which lithium niobate (LiNbO₃: hereinafter referred to as LN) having a high nonlinear constant is applied has been put into practical use already as a light source that is commercially available because of its high wavelength conversion efficiency.

The principle of wavelength conversion using the second-order nonlinear optical effect will be described below. In the second-order nonlinear optical effect, light having wavelengths λ₁ and λ₂ is input to generate new light having wavelength λ₃. The wavelength conversion satisfying (Equation 1) is called sum frequency generation (hereinafter referred to as SFG).

$$1 / {λ}_{3} = 1 / {λ}_{1} + 1 / {λ}_{2} \qquad ( Equation 1 )$$

Here, n₃ is a refractive index at wavelength λ₃, n₂ is a refractive index at wavelength λ₂, and n₁ is a refractive index at wavelength λ₁. In particular, wavelength conversion satisfying (Equation 2) obtained by modifying (Equation 1) with λ₁=λ₂ is called second harmonic generation (hereinafter referred to as SHG).

$${λ}_{3} = {λ}_{1} / 2 \qquad ( Equation 2 )$$

On the other hand, wavelength conversion satisfying (Equation 3) is called difference frequency generation (hereinafter referred to as DFG).

$$1 / {λ}_{3} = 1 / {λ}_{1} - 1 / {λ}_{2} \qquad ( Equation 3 )$$

There is also an optical parametric effect in which only λ₁ is input to generate λ₂ and λ₃ satisfying (Equation 3). SHG and SFG newly generate light having a short wavelength, that is, light having high energy with respect to incident light, and are often used for generating visible light and the like. On the other hand, DFG converts light having a short wavelength into light having a long wavelength, and is often used for generating light having a mid-infrared range or a longer wavelength than the mid-infrared range.

In order to generate such a second-order nonlinear optical effect with high efficiency, it is required that the phase mismatch amount with respect to the three interacting light beams is zero. As a method of setting this phase mismatch amount to zero in a pseudo manner, a periodically poled structure is exemplified.

FIG. 1 is a perspective view conceptually illustrating a wavelength conversion element 10 having periodically poled structure according to the related art. The wavelength conversion element 10 having a periodically poled structure according to the related art includes a substrate 11 and a core 12 that is bonded onto the substrate and performs wavelength conversion on incident light. Furthermore, the core 12 has a structure in which a region (hereinafter referred to as a positive core region) 121 in which the nonlinear constant indicates a positive value and a region (hereinafter referred to as a negative core region) 122 in which the nonlinear constant indicates a negative value are periodically exchanged. In this way, the periodically poled structure is a structure in which the positive and negative of the nonlinear constant are alternately switched by periodically inverting spontaneous polarization of a second-order nonlinear optical material in the optical axis direction. Then, assuming that the inversion period is Λ, in the sum frequency generation shown in (Equation 1), if Λ is set to satisfy (Equation 4) for the wavelengths λ₁, λ₂, and λ₃, the phase mismatch amount can be set to zero in a pseudo manner.

$${n}_{3} / {λ}_{3} - {n}_{2} / {λ}_{2} - {n}_{1} / {λ}_{1} - 1 / Λ = 0 \qquad ( Equation 4 )$$

By employing such a periodically poled structure and further forming the wavelength conversion element into a waveguide, that is, by confining light in a narrow region with high density and propagating the light over a long distance, a wavelength conversion element with high efficiency is obtained. In particular, a ridge waveguide in which a core is bonded onto a substrate is excellent in resistance to high light damage, long-term reliability, ease of device design, and the like because the characteristics of the crystal bulk applied to the core can be used as it is, and research and development have been actively conducted (see, for example, Non Patent Literature 1). A wavelength conversion element having a ridge waveguide structure is manufactured by bonding a core partially formed with a periodically poled structure satisfying a phase matching condition in a predetermined wavelength band in advance and a substrate holding the core, thinning the core, and then performing ridge processing. In the related art, an adhesive has been used for bonding the core and the substrate, but in recent years, a direct bonding technology has been applied to bond the core and the substrate to each other with high strength, and peeling/cracking at a bonding interface has been suppressed, so that the wavelength conversion element has been further improved in efficiency and life.

In addition, in a wavelength conversion element having a ridge waveguide structure, in order to confine light in a direction perpendicular to the optical axis direction (width direction of the core), a technology is known in which a core or a substrate is partially cut using a dicing saw, and an air layer having a low refractive index is introduced (see, for example, Non Patent Literature 1). In addition, in recent years, a technology for forming a waveguide by a dry etching method has also been reported (see, for example, Non Patent Literature 2). In the wavelength conversion element manufactured by such a method, the incident light to be guided and the conversion light to be emitted wavelength-convert light of transverse magnetic wave (TM) polarized light in which the optical electric field is biased in the direction perpendicular to the substrate.

As an example, in a wavelength conversion element in which an LN crystal is applied to a core, a case of performing wavelength conversion by DFG at 25° C., which is near room temperature, will be considered. Assuming that λ₁=0.98 μm and λ₂=1.47 μm are wavelengths of two incident light beams input to the wavelength conversion element, wavelength λ₃ of the conversion light beam emitted from the wavelength conversion element becomes 2.94 μm from (Equation 3). Here, considering the phase mismatch amount, from (Equation 4), the polarization inversion period A for phase matching is calculated to be 28.48 μm using the relationship of the refractive index dispersion of the LN at each light wavelength. That is, if the core has a structure in which the spontaneous polarization of the LN is inverted with a period of 28.48 um with respect to the optical axis direction, wavelength conversion is performed with high efficiency.

However, in the wavelength conversion by the wavelength conversion element, there may be a problem that unintended conversion light is generated due to high-order quasi-phase matching, and the desired wavelength conversion efficiency decreases accordingly. For example, considering the combination of light having wavelengths of λ₁ (0.98 μm) and λ₂ (1.47 μm) mentioned in the example of wavelength conversion by the DFG above, conversion light having a wavelength of 0.588 μm may be generated by the SFG, as can be understood from (Equation 1). The inversion period in the wavelength conversion by the SFG is 9.49 μm, which is exactly three times the inversion period (Λ=28.48 μm) in which the quasi-phase matching of the wavelength conversion by the DFG of the above example is established. When such a condition is satisfied, in this combination of incident light, higher-order quasi-phase matching is established with respect to the SFG, and wavelength conversion by the SFG is also simultaneously performed with relatively high efficiency.

The occurrence of such high-order quasi-phase matching is caused by the fact that the nonlinear constant can take only either a value of +d or −d, and cannot take an intermediate value, and thus modulation (modulation function) of the nonlinear constant becomes a rectangular function in the polarization inversion periodic structure. That is, when a rectangular function configured by binary values of −1 and 1 is subjected to Fourier series expansion, it is expressed as in (Equation 5), odd-order sin components such as sin (3x) and sin (5x) exist in addition to sin (x), and thus odd-order quasi-phase matching occurs.

$$f ( x ) = 4 / π \times \{ sin ( x ) + 1 / 3 \times sin ( 3 x ) + 1 / 5 \times sin ( 5 x ) + 1 / 7 \times sin ( 7 x ) + … \} \qquad ( Equation 5 )$$

Therefore, with respect to the polarization inversion period Λ, conversion light having an unintended wavelength (parasitic wavelength) in which a period obtained by dividing the inversion period A such as Λ/3 or Λ/5 by an odd integer is regarded as a new polarization inversion period is generated.

In this way, when the DFG is caused, the SFG occurs parasitically, and the energy of the incident light is shifted to a short wavelength by the SFG, so that the energy of the incident light contributing to the DFG decreases, and as a result, a problem arises that the intensity of the conversion light subjected to wavelength conversion by the DFG decreases.

As the related art for suppressing such parasitic occurrence of unintended wavelength conversion, there is a method of inserting a phase adjustment layer into a core (see, for example, Non Patent Literature 1). However, in such a method for suppressing parasitic wavelength conversion according to the related art, since parasitic wavelength conversion occurs until the phase adjustment layer is reached, the intensity of incident light that is a source for obtaining desired wavelength conversion light decreases accordingly. That is, it is not possible to efficiently suppress parasitic wavelength conversion, and there is a problem that an intended decrease in the intensity of the wavelength conversion light occurs to a considerable extent.

### Citation List

### Non Patent Literature

Non Patent Literature 1: Y. Nishida, H. Miyazawa, M. Asobe, O. Tadanaga, and H. Suzuki, “Direct-bonded QPM-LN ridge waveguide with high damage resistance at room temperature”, Electronics Letters, Vol. 39, No. 7, p. 609-611, 2003.

Non Patent Literature 2: T. Umeki, O. Tadanaga, and M. Asobe, “Highly Efficient Wavelength Converter Using Direct-Bonded PPZnLN Ridge Waveguide”, IEEE Journal of Quantum Electronics, Vol. 46, No. 8, pp. 1206-1213, 2010.

### SUMMARY OF INVENTION

The present disclosure has been made in view of the above problems, and an object of the present disclosure is to provide a wavelength conversion element capable of suppressing unintended wavelength conversion due to high-order quasi-phase matching.

In order to solve the above problem, the present disclosure provides a wavelength conversion element having a waveguide structure using a second-order nonlinear optical effect, the wavelength conversion element including: a substrate; and a core that is bonded onto the substrate and performs wavelength conversion of incident light, in which the core has a structure in which first spontaneous polarization and second spontaneous polarization are periodically inverted with respect to an optical axis direction, and the wavelength conversion element has a structure in which a cross-sectional area of the core changes with respect to the optical axis direction such that the cross-sectional area is maximum at an end portion and is minimum at a central portion in a region having the first spontaneous polarization and a region having the second spontaneous polarization.

### BRIEF DESCRIPTION OF DRAWINGS

FIG. 1 is a perspective view conceptually

illustrating a wavelength conversion element having a periodically poled structure according to the related art.

FIG. 2 is a set of diagrams illustrating modulation curves in a wavelength conversion element, in which FIG. 2(a) illustrates a modulation curve in a case of using a wavelength conversion element according to the related art, and FIG. 2(b) illustrates an ideal modulation curve for suppressing wavelength conversion for unintended wavelength conversion.

FIG. 3 is a set of conceptual diagrams illustrating a structure of a wavelength conversion element according to the present disclosure, in which FIG. 3(a) is a perspective view and FIG. 3(b) is a top view.

FIG. 4 is a diagram conceptually illustrating a modulation curve in a core of a wavelength conversion element according to an embodiment of the present disclosure.

FIG. 5 is a diagram illustrating a calculation result of a phase matching pattern in a case where a wavelength conversion element according to the related art and a wavelength conversion element according to the present disclosure are used.

FIG. 6 is a set of conceptual diagrams illustrating a structure of a wavelength conversion element according to the present disclosure, in which FIG. 6(a) is a perspective view and FIG. 6(b) is a front view.

FIG. 7 is a set of conceptual diagrams illustrating a structure of a wavelength conversion element 70 according to the present disclosure, in which FIG. 7(a) is a perspective view, FIG. 7(b) is a top view, and FIG. 7(c) is a front view.

FIG. 8 is a set of conceptual diagrams illustrating a structure of a wavelength conversion element 80 according to the present disclosure, in which FIG. 8(a) is a perspective view and FIG. 8(b) is a top view.

### DESCRIPTION OF EMBODIMENTS

Various embodiments of the present disclosure will be described in detail below with reference to the drawings. The same or similar reference signs denote the same or similar components, and redundant description may be omitted. The materials and numerical values are for illustrative purposes and are not intended to limit the scope of the disclosure. The following description is an example, and some configurations may be omitted, modified, or implemented together with additional configurations without departing from the gist of an embodiment of the present disclosure.

The present disclosure proposes a wavelength conversion element configured to perform modulation that reduces wavelength conversion efficiency for unintended wavelength conversion. In addition, in order to reduce the wavelength efficiency for unintended wavelength conversion, the cross-sectional area of the core through which light propagates changes with respect to the optical axis direction, which is different from the related art.

In general, the wavelength conversion efficiency in the waveguide type wavelength conversion element depends on the nonlinear constant, the length, and the cross-sectional area of the core constituting the waveguide (specifically, it is proportional to the square of the nonlinear constant and the square of the length, and is inversely proportional to the cross-sectional area). However, since the nonlinear constant of the core is a parameter that depends on the material, it is substantially difficult to change the nonlinear constant. In addition, since the length of the core is also limited by the size of the substrate, it is difficult to similarly change the length. Therefore, in the wavelength conversion element according to the present disclosure, the efficiency of unintended wavelength conversion is reduced by changing the cross-sectional area of the core.

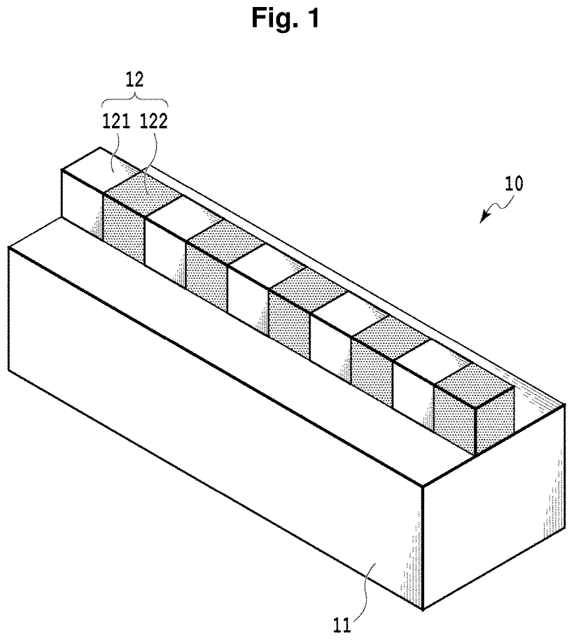

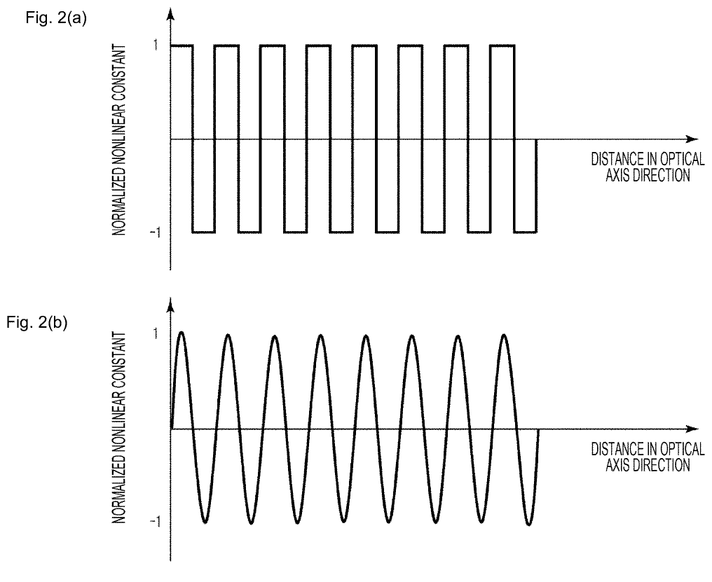

FIG. 2 is a set of diagrams illustrating modulation curves in a wavelength conversion element, in which FIG. 2(a) illustrates a modulation curve in a case of using a wavelength conversion element according to the related art, and FIG. 2(b) illustrates an ideal modulation curve for suppressing wavelength conversion for unintended wavelength conversion. In the wavelength element according to the related art as illustrated in FIG. 1, the core has a structure in which the cross-sectional area is constant with respect to the optical axis direction. In the wavelength conversion element having such a structure, as described above, since the nonlinear constant takes only a binary value of +d or −d, the modulation curve is a rectangular function. On the other hand, in order to suppress wavelength conversion for unintended wavelength conversion, it is ideal that the modulation curve is a sine function in which the nonlinear constant becomes zero at the interface where the spontaneous polarization of the core is inverted. This is because, in the Fourier series expansion described above, if the original function is the sine function, a high-order term is not generated.

However, in order to set the nonlinear constant to zero at the interface where the spontaneous polarization of the core is inverted, the cross-sectional area of the core at the interface needs to diverge to infinity. That is, it can be said that the structure is practically impossible. However, even if the function is not a complete sine function, if modulation is performed such that a modulation curve having a shape close to the complete sine function is obtained, it is possible to reduce the wavelength conversion efficiency for unintended wavelength conversion.

As described above, the present disclosure proposes a wavelength conversion element having a structure in which, in a region having one spontaneous polarization, a cross-sectional area is large at an end portion in an optical axis direction and is small at a central portion. With such a structure, the modulation curve has a shape close to the sine function, having a peak at the central portion in the optical axis direction. Therefore, it is possible to reduce the wavelength conversion efficiency for unintended wavelength conversion.

### (First Embodiment)

A first embodiment according to the present disclosure will be described in detail below with reference to the drawings. The wavelength conversion element according to the present embodiment has a structure in which the cross-sectional area of the core in the optical axis direction takes a maximum value at the end portion and a minimum value at the central portion, and the cross-sectional area linearly changes from the end portion to the central portion.

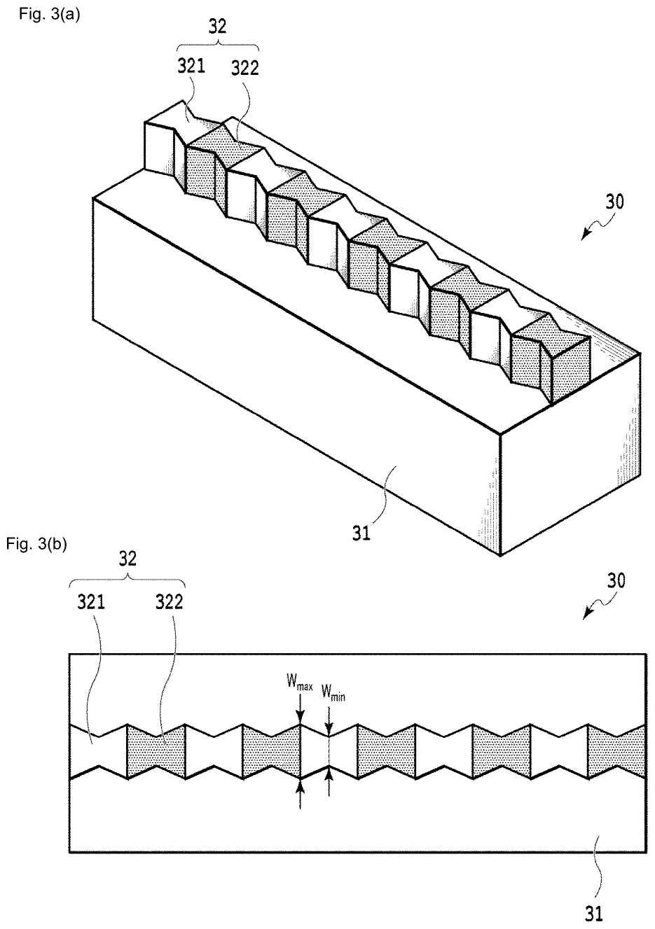

FIG. 3 is a set of conceptual diagrams illustrating a structure of a wavelength conversion element 30 according to the present disclosure, in which FIG. 3(a) is a perspective view and FIG. 3(b) is a top view. The wavelength conversion element 30 according to the present disclosure includes a substrate 31 and a core 32 that is bonded onto the substrate and performs wavelength conversion of incident light. Further, the core 32 includes a positive core region 321 and a negative core region 322, and has a periodically poled structure in which the positive core region 321 and the negative core region 322 are periodically inverted with respect to the optical axis direction. In addition, as illustrated in FIG. 3(b), each of the positive core region 321 and the negative core region 322 has a structure in which the cross-sectional area is maximized at the end portion in the optical axis direction in each core region and the cross-sectional area is minimized at the central portion in the optical axis direction in each core region. In addition, the cross-sectional area linearly changes from the end portion to the central portion. More specifically, each core region has a structure in which the height (the length in the direction perpendicular to the main surface of the substrate 31) is constant, the width (the length in the direction perpendicular to the main surface of the substrate 31 and the direction orthogonal to the optical axis direction) decreases at a constant rate from one end portion toward the central portion, and increases at a constant rate from the central portion toward the other end portion. The width of each core region changes (that is, decreases and increases) in line symmetry about the center line of the core region parallel to the optical axis direction. The cross section of each core region is rectangular.

As an example, in the wavelength conversion element 30 according to the present embodiment, lithium tantalate (LiTaO₃: hereinafter referred to as LT) is applied to the substrate 31, LN is applied to the core 32, and the thickness of the core 32 is 1 μm and the length thereof is 12 mm. In each of the positive core region 321 and the negative core region 322, a width Wmax at the position where the cross-sectional area is maximum (that is, the end portion) is 16 μm, and a width Wmin at the position where the cross-sectional area is minimum (that is, the central portion) is 8 μm.

In the wavelength conversion element 30 according to the present embodiment, the substrate 31 and the core 32 are bonded by direct bonding. In addition, it is assumed that a resist is patterned in advance by lithography so that the core 32 has the above-described shape and is formed along the pattern by a dry etching method. However, the manufacturing method is not limited thereto, and for example, in order to form the core into the above-described shape, a laser ablation method or the like may be applied in which processing is performed by emitting a high-intensity laser and evaporating the laser.

In the wavelength conversion element 30 according to the present embodiment having such a configuration, the wavelength conversion efficiency changes according to the distance with respect to the optical axis direction in each of the positive core region 321 and the negative core region 322. Therefore, the core 32 of the wavelength conversion element 30 behaves as if the nonlinear constant is continuously different with respect to the optical axis direction. Hereinafter, in the present specification, a nonlinear constant that is assumed to change in a pseudo manner with such a change in cross-sectional area is referred to as an “apparent nonlinear constant”.

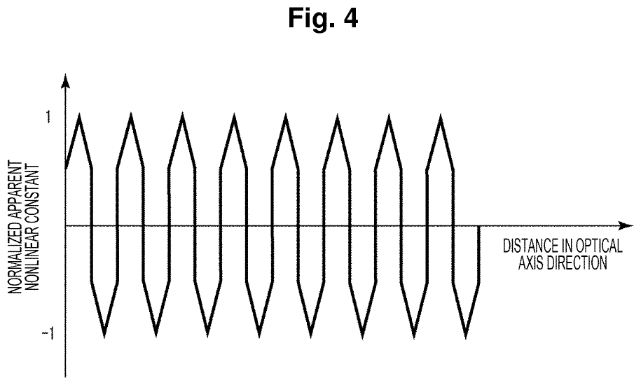

FIG. 4 is a diagram conceptually illustrating a modulation curve in the core 32 of the wavelength conversion element 30 according to the embodiment of the present disclosure. Here, the vertical axis represents an apparent nonlinear constant. As illustrated in FIG. 4, in the wavelength conversion element 30 according to the embodiment of the present disclosure, the wavelength modulation curve is not rectangular, but has a mountain-shaped waveform in which an apparent nonlinear constant has a peak at a central portion of each core region. Therefore, high-order sin components such as sin (3x) and sin (5x) are reduced by Fourier series expansion as shown in (Equation 5), and the efficiency of wavelength conversion due to unintended quasi-phase matching is reduced.

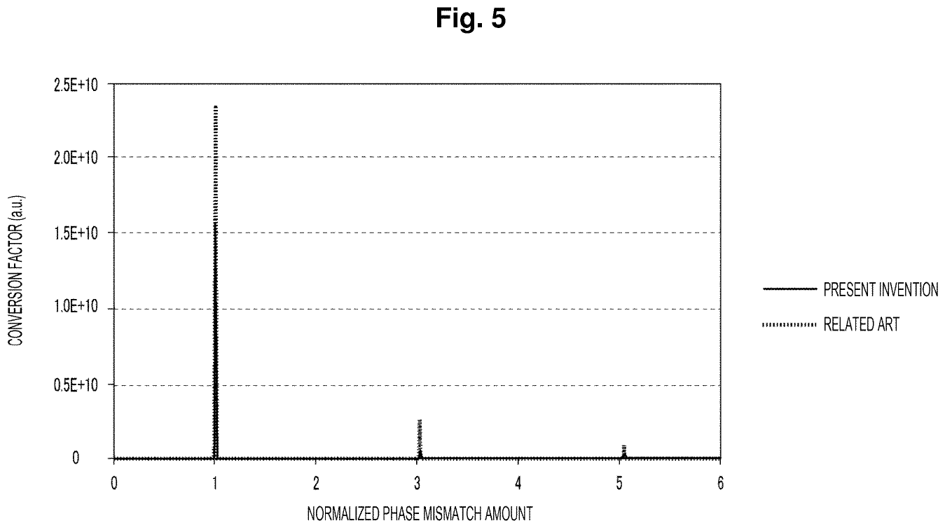

FIG. 5 is a diagram illustrating a calculation result of a phase matching pattern in a case where the wavelength conversion element 10 according to the related art and the wavelength conversion element 30 according to the present disclosure are used. The horizontal axis in FIG. 5 represents the normalized phase mismatch amount, but this value may be considered as the order of the quasi-phase matching. The inversion of the spontaneous polarization is 1000 cycles. In addition, the width of the core 12 of the wavelength conversion element 10 according to the related art is constant at 8 um, and the other dimensions are the same as those of the wavelength conversion element 30 according to the present disclosure described above. As illustrated in FIG. 5, in a case where the wavelength conversion element 30 according to the present disclosure is used as compared with the related art, the wavelength conversion efficiency is generally reduced, and in particular, the wavelength conversion efficiency is significantly reduced in higher order such as the third order and the fifth order. In fact, when considering the wavelength conversion efficiency in the case of using the wavelength conversion element 10 according to the related art as a reference, the reduction rate of the wavelength conversion efficiency in the case of using the wavelength conversion element 30 according to the present disclosure is about 33% in the first order, whereas the reduction rate is 84% in the third order and 68% in the fifth order. From this, it can be seen that the wavelength conversion element 30 according to the present disclosure can reduce the conversion efficiency for unintended wavelength conversion due to high-order quasi-phase matching. Although the first-order (desired) wavelength conversion efficiency is also reduced, this can be improved by, for example, increasing the power of the incident light.

In the present embodiment, as an example, a structure is used in which the modulation curve from the end portion to the central portion is linearly changed, but the present disclosure is not limited thereto, and for example, the modulation curve may change to have a curvature.

In addition, in the present embodiment, LN is applied to the core, but a material containing at least one of Mg, Zn, Sc, and In as an additive to LN may be used.

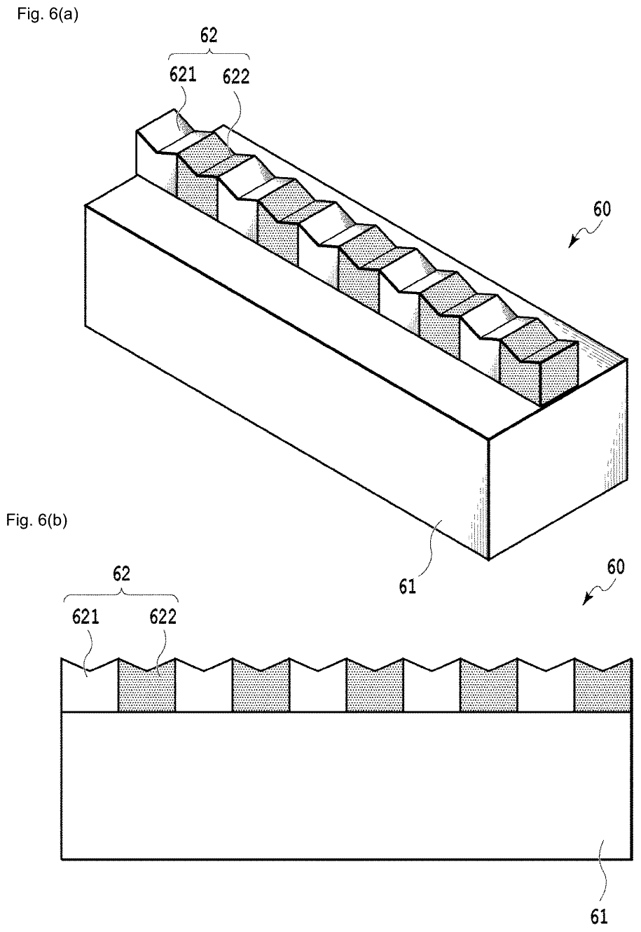

FIG. 6 is a set of conceptual diagrams illustrating a structure of a wavelength conversion element 60 according to the present disclosure, in which FIG. 6(a) is a perspective view and FIG. 6(b) is a front view. The wavelength conversion element 60 illustrated in FIG. 6 includes a substrate 61 and a core 62 that is bonded onto the substrate and performs wavelength conversion of incident light, similarly to the wavelength conversion element 30 described above. Further, the core 62 includes a positive core region 621 and a negative core region 622, and has a periodically poled structure in which the positive core region 621 and the negative core region 622 are periodically inverted with respect to the optical axis direction. In addition, as illustrated in FIG. 6(b), each of the positive core region 621 and the negative core region 622 has a structure in which the cross-sectional area is maximized at the end portion in the optical axis direction in each core region and the cross-sectional area is minimized at the central portion in the optical axis direction in each core region. However, in the wavelength conversion element 60, each core region has a structure in which the width (the length in the direction perpendicular to the main surface of the substrate 61 and the direction orthogonal to the optical axis direction) is constant, the height (the length in the direction perpendicular to the main surface of the substrate 61) decreases at a constant rate from one end portion toward the central portion, and increases at a constant rate from the central portion toward the other end portion.

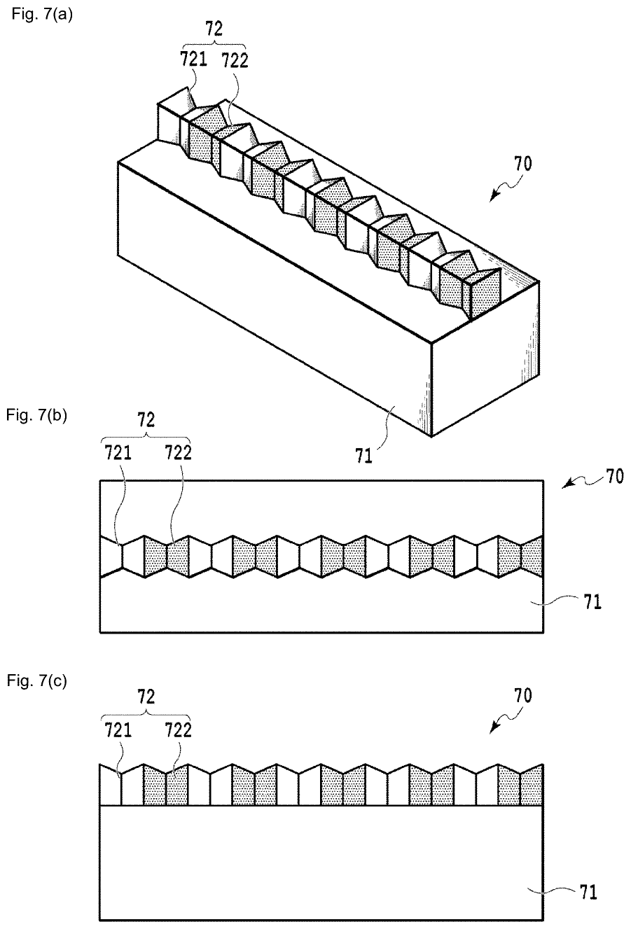

FIG. 7 is a set of conceptual diagrams illustrating a structure of a wavelength conversion element 70 according to the present disclosure, in which FIG. 7(a) is a perspective view, FIG. 7(b) is a top view, and FIG. 7(c) is a front view. The wavelength conversion element 70 illustrated in FIG. 7 includes a substrate 71 and a core 72 that is bonded onto the substrate and performs wavelength conversion of incident light, similarly to the wavelength conversion element 30 and the wavelength conversion element 60 described above. Further, the core 72 includes a positive core region 721 and a negative core region 722, and has a periodically poled structure in which the positive core region 721 and the negative core region 722 are periodically inverted with respect to the optical axis direction. In addition, as illustrated in FIGS. 7(b) and 7(c), each of the positive core region 721 and the negative core region 722 has a structure in which the cross-sectional area is maximized at the end portion in the optical axis direction in each core region and the cross-sectional area is minimized at the central portion in the optical axis direction in each core region. However, unlike the wavelength conversion element 30 and the wavelength conversion element 60, in the wavelength conversion element 70, each core region has a structure in which both the width (the length in the direction perpendicular to the main surface of the substrate 71 and the direction orthogonal to the optical axis direction) and the height (the length in the direction perpendicular to the main surface of the substrate 71) decrease at a constant rate from one end portion toward the central portion, and increase at a constant rate from the central portion toward the other end portion.

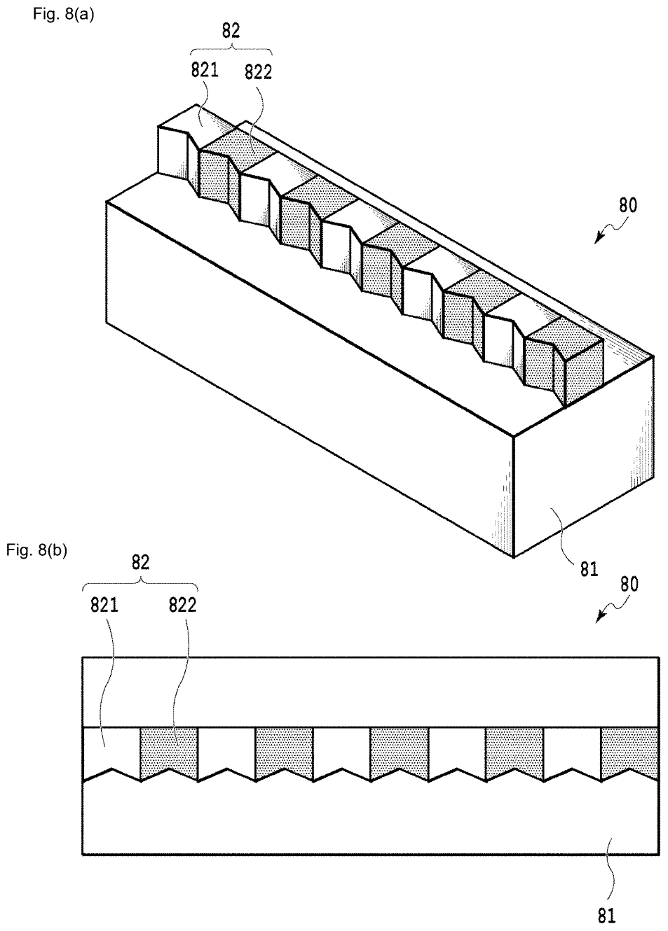

FIG. 8 is a set of conceptual diagrams illustrating a structure of a wavelength conversion element 80 according to the present disclosure, in which FIG. 8(a) is a perspective view and FIG. 8(b) is a top view. The wavelength conversion element 80 illustrated in FIG. 8 includes a substrate 81 and a core 82 that is bonded onto the substrate and performs wavelength conversion of incident light, similarly to the wavelength conversion elements 30, 60 and 70 described above. Further, the core 82 includes a positive core region 821 and a negative core region 822, and has a periodically poled structure in which the positive core region 821 and the negative core region 822 are periodically inverted with respect to the optical axis direction. In addition, as illustrated in FIG. 8 (b), each of the positive core region 821 and the negative core region 822 has a structure in which the cross-sectional area is maximized at the end portion in the optical axis direction in each core region and the cross-sectional area is minimized at the central portion in the optical axis direction in each core region. However, unlike the wavelength conversion elements 30, 60, and 70, in the width of each core region, the length from the center line of the core region parallel to the optical axis direction changes (that is, decreases and increases) in a non-line-symmetric manner.

Even in the wavelength conversion elements 60, 70, and 80 having such a configuration, similarly to the wavelength conversion element 30, the conversion efficiency can be reduced for unintended wavelength conversion due to high-order quasi-phase matching.

Note that each of the wavelength conversion elements 60, 70, and 80 has a structure in which the modulation curve from the end portion to the central portion is linearly changed, but the present disclosure is not limited thereto similarly to the wavelength conversion element 30, and for example, the modulation curve may change to have a curvature.

In addition, the wavelength conversion element according to the present disclosure is described such that the cross-sectional shape of each core region with respect to the optical axis direction is a square or a rectangle in the above-described embodiment, but is not limited thereto. For example, the cross-sectional shape of each core region with respect to the optical axis direction may be a trapezoid. Further, the surface of each core region not bonded to the substrate may have a curvature.

### Industrial Applicability

The wavelength conversion element according to the present disclosure has an effect of suppressing unintended high-order wavelength conversion as compared with the related art. Therefore, since desired wavelength conversion is performed more efficiently, application to a laser light source or the like used in the fields of optical communication, optical processing, and the like is expected as a wavelength conversion element with higher efficiency than the related art.

1. A wavelength conversion element having a waveguide structure using a second-order nonlinear optical effect, the wavelength conversion element comprising:
a substrate; and
a core that is bonded onto the substrate and performs wavelength conversion of incident light,
wherein
the core has a structure in which first spontaneous polarization and second spontaneous polarization are periodically inverted with respect to an optical axis direction, and
the wavelength conversion element has a structure in which a cross-sectional area of the core changes with respect to the optical axis direction such that the cross-sectional area is maximum at an end portion and is minimum at a central portion in a region having the first spontaneous polarization and a region having the second spontaneous polarization.

2. The wavelength conversion element according to claim 1, wherein the cross-sectional area of the core linearly changes with respect to the optical axis direction from the end portion to the central portion.

3. The wavelength conversion element according to claim 1, wherein the cross-sectional area of the core changes to have a curvature with respect to the optical axis direction from the end portion to the central portion.

4. The wavelength conversion element according to claim 1, wherein a material applied to the core is selected from LiNbO₃, LiTaO₃, and a material containing at least one of Mg, Zn, Sc, and In as an additive to LiNbO₃ and LiTaO₃.

5. The wavelength conversion element according to claim 2, wherein a material applied to the core is selected from LiNbO₃, LiTaO₃, and a material containing at least one of Mg, Zn, Sc, and In as an additive to LiNbO₃ and LiTaO₃.

6. The wavelength conversion element according to claim 3, wherein a material applied to the core is selected from LiNbO₃, LiTaO₃, and a material containing at least one of Mg, Zn, Sc, and In as an additive to LiNbO₃ and LiTaO₃.
